(19) United States
(12) Patent Application Publication
(10) Pub. No.: US 2019/0045138 A1
(43) Pub. Date: Feb. 7, 2019

(54) Apparatuses for Concurrent Multiple Image Recording and Systems Incorporating the Same

(71) Applicant: Delitor, Inc., Charlotte, NC (US)

(72) Inventor: Glenn Devitt, Huntersville, NC (US)

(73) Assignee: Delitor, Inc., Charlotte, NC (US)

(21) Appl. No.: 16/046,314

(22) Filed: Jul. 26, 2018

Related U.S. Application Data
(60) Provisional application No. 62/539,713, filed on Aug. 1, 2017.

(51) Int. Cl. H04N 5/247; A42B 3/04; H04N 5/225; H04N 5/232; H04N 5/33

(52) U.S. Cl. CPC H04N 5/247; A42B 3/042; H04N 5/332; H04N 5/2253; H04N 5/23238; H04N 5/2252

(57) ABSTRACT

Image recording apparatuses that permit the recording of multiple images in different directions are generally disclosed herein. In some embodiments, such apparatuses have two or more image sensors that can be disposed at disparate locations from each other and from the controller and the power supply, thereby allowing for a more distributed physical configuration and a lower profile when disposed on a hat, helmet, or other headgear. In some such embodiments, the image sensors of the recording apparatus are configured to be disposed at disparate locations on a head covering device, such as a hat or helmet. In some aspects, the image recording apparatuses can be incorporated into a system for panoramic (e.g., 360°) image recording. Uses of such apparatuses and systems are also disclosed herein.

### CROSS-REFERENCE TO RELATED APPLICATIONS

The present application claims the benefit of priority of U.S. Provisional Application No. 62/539,713, filed Aug. 1, 2017, which is hereby incorporated by reference as set forth herein in its entirety.

### TECHNICAL FIELD

Image recording apparatuses that permit the recording of multiple images in different directions are generally disclosed herein. In some embodiments, such apparatuses have two or more image sensors that can be disposed at disparate locations from each other and from the controller and the power supply, thereby allowing for a more distributed physical configuration and a lower profile when disposed on a hat, helmet, or other headgear. In some such embodiments, the image sensors of the recording apparatus are configured to be disposed at disparate locations on a head covering device, such as a hat or helmet. In some aspects, the image recording apparatuses can be incorporated into a system for panoramic (e.g., 360°) image recording. Uses of such apparatuses and systems are also disclosed herein.

### BACKGROUND

Cameras that record images in 360 degrees have become common in recent years, and have found use in a wide array of settings. Such devices come in a variety of configurations. In general, these devices exist within a single assembly, where the image sensors, the controller, the power supply, and all other components exist as part of a unitary piece or housing.

This common-housing approach places certain limits on the versatility of such cameras. For example, in some cases, the units can be quite bulky, especially if they include a power supply (battery) designed to have a lifetime of several hours or more. When such devices are placed atop a helmet or other headgear, they have a large vertical profile and can be quite inconvenient for the user to wear. To remedy this problem, smaller units have been developed. But the small size usually comes at the expense of battery lifetime, as the size reduction is generally achieved by swapping out a longer-lifetime (and bigger) battery for a shorter-lifetime (and smaller) battery. So, while such devices may be more convenient to use, they can easily lose battery power before the user has a reasonable opportunity to recharge. Thus, such apparatuses are not useful in situations where the user may want to continue recording for a number of hours or is unable to access an electrical port for recharging.

Thus, there is a continuing need to develop panoramic camera systems that permit recording for longer periods of time and that simultaneously have a small profile, especially when used in conjunction with a hat, helmet or other headwear.

### SUMMARY

In a first aspect, the disclosure provides an apparatus for concurrent multiple image recording, comprising: two or more image sensors, wherein the two or more image sensors are configured to be disposed at disparate locations on an external surface of a head covering device; a controller that is in electrical communication with the two or more image sensors, and is configured to activate the two or more image sensors to capture image data; a data storage unit that is in electrical communication with the two or more image sensors and the processor, when present, and is configured to store image data captured by the two or more image sensors or processed image data generated by the processor; and a power supply, wherein the power supply is configured to be disposed at a location remote from at least one of the two or more image sensors.

In a second aspect, the disclosure provides a system for panoramic image recording, comprising: a head covering device having an external surface, the external surface having an anterior portion and a posterior portion; two or more image sensors, wherein a first image sensor of the two or more image sensors is disposed on the anterior portion of the external surface of the head covering device, and a second image sensor of the two or more image sensors is disposed on the posterior portion of the external surface of the head covering device; a controller that is in electrical communication with the two or more image sensors, and is configured to activate the two or more image sensors to capture image data; a data storage unit that is in electrical communication with the two or more image sensors and the processor, when present, and is configured to store image data captured by the two or more image sensors or processed image data generated by the processor; and a power supply, wherein the power supply is disposed at a location remote from the first image sensor.

In certain other aspects, the disclosure provides various uses of the foregoing apparatuses and systems. These and other aspects and embodiments are set forth in the foregoing drawings, detailed description, and claims.

### BRIEF DESCRIPTION OF THE DRAWINGS

FIG. 1 shows an embodiment of the image recording apparatuses disclosed herein.

FIG. 2 shows an embodiment of the image recording apparatuses disclosed herein.

FIG. 3 shows an embodiment of the image recording apparatuses disclosed herein.

FIG. 4 shows an embodiment of the image recording system disclosed herein.

FIG. 5 shows an embodiment of the image recording system disclosed herein.

FIG. 6 shows an embodiment of the image recording system disclosed herein.

### DETAILED DESCRIPTION

The following description recites various aspects and embodiments of the inventions disclosed herein. No particular embodiment is intended to define the scope of the invention. Rather, the embodiments provide non-limiting examples of various compositions, and methods that are included within the scope of the claimed inventions. The description is to be read from the perspective of one of ordinary skill in the art. Therefore, information that is well known to the ordinarily skilled artisan is not necessarily included.

### Definitions

The following terms and phrases have the meanings indicated below, unless otherwise provided herein. This disclosure may employ other terms and phrases not expressly defined herein. Such other terms and phrases shall have the meanings that they would possess within the context of this disclosure to those of ordinary skill in the art. In some instances, a term or phrase may be defined in the singular or plural. In such instances, it is understood that any term in the singular may include its plural counterpart and vice versa, unless expressly indicated to the contrary.

As used herein, the singular forms “a,” “an,” and “the” include plural referents unless the context clearly dictates otherwise. For example, reference to “a substituent” encompasses a single substituent as well as two or more substituents, and the like.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure, and are not meant to be limiting in any fashion. Nor do these phrases indicate any kind of preference for the disclosed embodiment.

As used herein, “optionally” means that the subsequently described event(s) may or may not occur. In some embodiments, the optional event does not occur. In some other embodiments, the optional event does occur one or more times.

As used herein, “comprise” or “comprises” or “comprising” or “comprised of” refer to groups that are open, meaning that the group can include additional members in addition to those expressly recited. For example, the phrase, “comprises A” means that A must be present, but that other members can be present too. The terms “include,” “have,” and “composed of” and their grammatical variants have the same meaning. In contrast, “consist of” or “consists of” or “consisting of” refer to groups that are closed. For example, the phrase “consists of A” means that A and only A is present.

As used herein, “or” is to be given its broadest reasonable interpretation, and is not to be limited to an either/or construction. Thus, the phrase “comprising A or B” means that A can be present and not B, or that B is present and not A, or that A and B are both present. Further, if A, for example, defines a class that can have multiple members, e.g., A₁ and A₂, then one or more members of the class can be present concurrently.

Other terms are defined in other portions of this description, even though not included in this subsection.

### Apparatus for Concurrent Multiple Image Recording

In a first aspect, the disclosure provides an apparatus for concurrent multiple image recording, comprising: two or more image sensors, wherein the two or more image sensors are configured to be disposed at disparate locations on an external surface of a head covering device; a controller that is in electrical communication with the two or more image sensors, and is configured to activate the two or more image sensors to capture image data; a data storage unit that is in electrical communication with the two or more image sensors and the processor, when present, and is configured to store image data captured by the two or more image sensors or processed image data generated by the processor; and a power supply, wherein the power supply is configured to be disposed at a location remote from at least one of the two or more image sensors.

The apparatuses disclosed herein have two or more image sensors (or cameras). Any suitable image sensor or camera can be used, so long as is capable of detecting and conveying information that constitutes an image. The image sensors can be analog or digital image sensors, but, in certain embodiments, are digital image sensors. The image sensors can be configured to detect images under various conditions, including, but not limited to, daylight image recording (where the sensor is configured to at least detect electromagnetic radiation in the visible light range), nighttime image recording (where the sensor is configured to at least detect electromagnetic radiation in the infrared or thermal range), radar image recording (where the sensor is configured to at least detect electromagnetic radiation in the radio range), sonar image recording (where the sensor is configured to at least detect sound waves), and the like. In some embodiments, the image sensors are visible-light image sensors, which at least detect electromagnetic radiation in the visible range. In some other embodiments, the image sensors are infrared image sensors, which at least detect electromagnetic radiation in the infrared range. In some further such embodiments, the infrared image sensors may also detect visible light at certain wavelengths, such as those wavelengths of visible light that may be useful to detect in nighttime conditions.

The apparatuses disclosed herein have at least two image sensors, according to any combination of the foregoing embodiments. In some embodiments, the apparatuses have two image sensors, or three image sensors, or four image sensors, or five image sensors, of six image sensors, of seven image sensors, or eight image sensors, or nine image sensors, or ten image sensors, or eleven image sensors, or twelve image sensors, and so on. The selection of the number of image sensors may depend on a variety of factors, including the scope of view one desires to detect, the aspect of the image sensors, the type of image-related information detected by the image sensors, and the like. In some embodiments, the apparatus includes four visible-light image sensors.

In the apparatuses disclosed herein, the two or more image sensors are configured to be disposed at disparate locations (i.e., locations remote from each other) on an external surface of a head covering device (e.g., a hat, helmet, and the like). Moreover, at least one of the two or more image sensors is configured to be disposed at a location remote from the power supply. For example, in some embodiments disclosed herein, the power supply (e.g., battery) is contained within a housing that may also include one or more of a controller, a data storage unit (e.g., memory), and a processor. In such embodiments, at least one of the two or more image sensors is configured to be disposed at a location remote from the housing. This can be accomplished in any suitable way. For example, in some embodiments, the one or more remote image sensors can be disposed on a member that extends from the housing, either as a flexible piece or a semi-rigid or rigid piece.

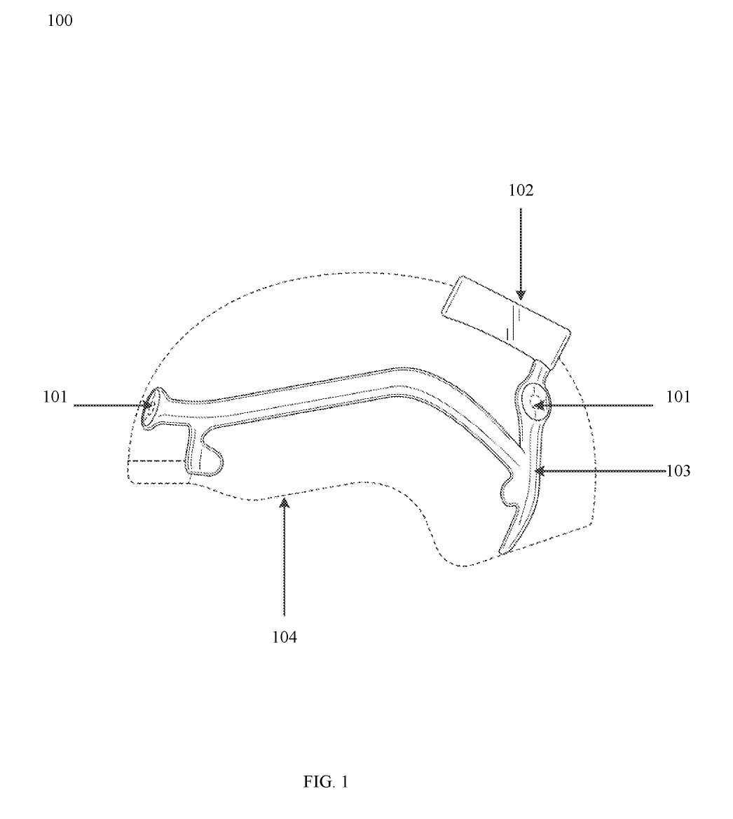

In some embodiments, the apparatus is configured to permit panoramic or 360-degree image capturing. In some such embodiments, In such embodiments, at least one, preferably at least two, of the two or more image sensors are configured to be disposed on an anterior portion of the head covering device, and at least another, or preferable at least two other, of the two or more image sensors are configured to be disposed on an posterior portion of the head covering device. An example of such a configuration is disclosed in FIGS. 1-3, described below.

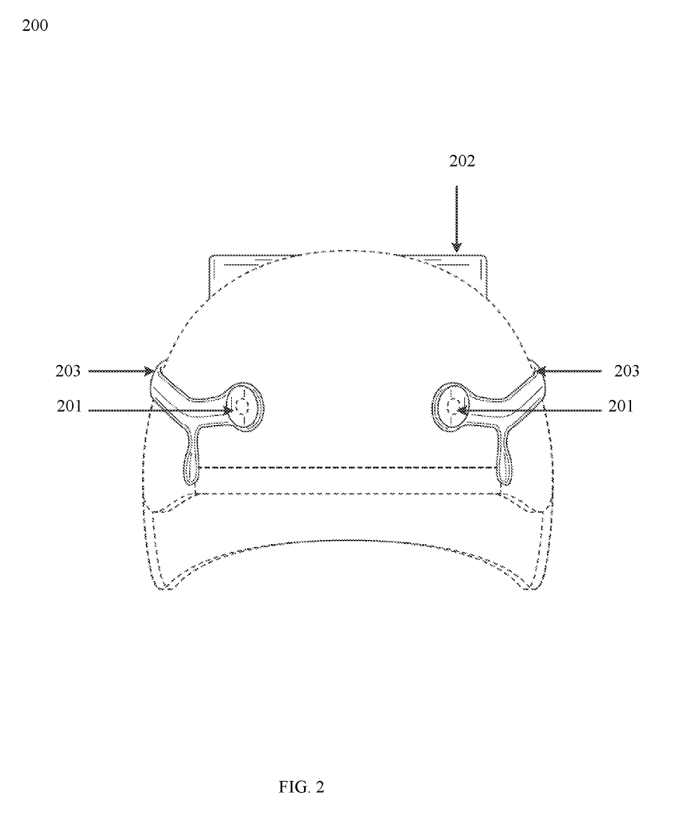

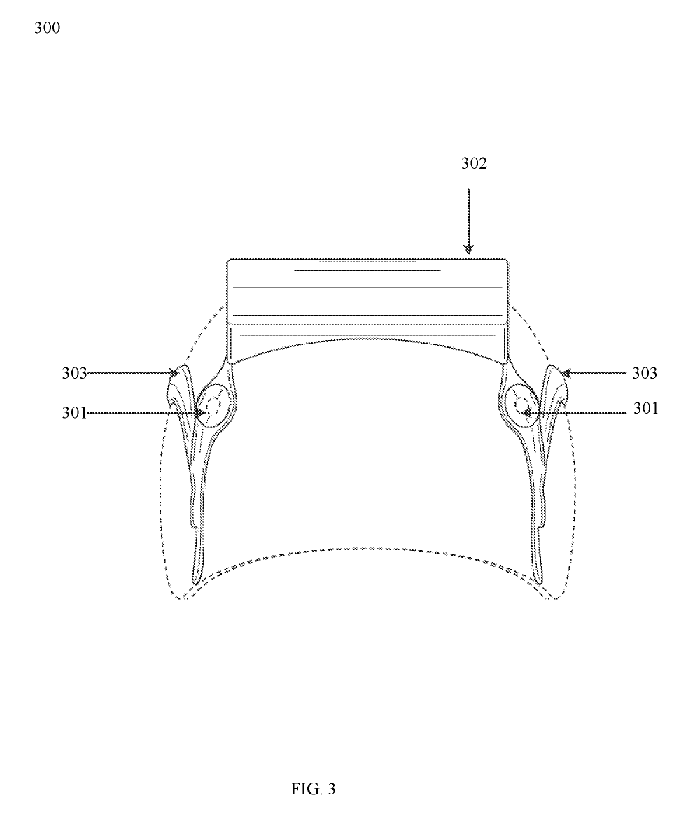

In some embodiments, all of the image sensors are configured to be disposed at locations remote from the power supply. In such embodiments, the two or more image sensors are disposed onto member(s) that extend from the housing containing the power supply. FIG. 1 shows a non-limiting example of such a configuration. FIG. 1 shows an image recording apparatus 100 having two remote image sensors 101 and a housing 102 that at least contains a power supply and a member 103 that extends from the housing 102 to permit disposing of the image sensors 101 at locations remote from the housing 102 and disparate from each other. The dotted lines in FIG. 1 show an outline of how such an apparatus can be disposed onto a head covering device, such as a helmet 104. The features illustrated in FIG. 1 can easily be extended to embodiments that incorporate additional image sensors and additional members extending from the housing. Also, in some alternative embodiments (not shown), one of the image sensors, such as the rear image sensor shown in FIG. 1, could be incorporated into the housing itself instead of being disposed on the extension member. Also, FIG. 1 shows a left-side view. In some embodiments, the image recording apparatus can be configured to allow for similar features to be present on the right side of a head covering device. In some embodiments, the image recording apparatus can be configured to allow for similar features to be present on both the left side and the right side of a head covering device, such that the apparatus has four image sensors and a housing that at least contains a power supply. FIG. 2 shows a front view of such an image recording apparatus 200, where two of the four remote image sensors 201 are connected to an extending member 203 to a housing 202 that at least contains a power supply. FIG. 3 shows a rear view of such an image recording apparatus 300, where two of the four remote image sensors 301 are connected to an extending member 303 to a housing 302 that at least contains a power supply.

The embodiments shown in FIGS. 1-3 illustrate at least certain benefits of the apparatuses disclosed herein. By separating some or all of the image sensors from the power supply, the image sensors can be disposed at locations that fit closely to the head or head covering device (i.e., without substantially increasing the profile) and that are suitable for image capturing, while the power supply can be placed at any location that is convenient without consideration of whether that location is suitable for image collection or not. For example, as illustrated in FIGS. 1-3, the housing containing a power supply is configured to be disposed on the lower anterior portion of a head covering device. This allows for the use of a larger battery, which permits longer lifetime before recharging or replacement. It also allows for placement of the housing containing the power supply at a location that is more comfortable to the user and that does not substantially extend beyond the profile of the head covering device in a vertical direction. By physically separating the image sensors from the housing, one can obtain certain benefits of a larger device without the need to affix a bulky unit atop the user's head.

As noted above, the image sensors are configured to be disposed on an external surface of a head covering. This can be accomplished by any suitable means, so long as the image sensors are configured to be disposed in a substantially fixed position relative to each other. In some embodiments, the extending members themselves can also serve as the head covering device, if they have sufficient rigidity to maintain the image sensors in a relatively fixed position relative to each other once disposed onto the head of a user. In some other embodiments, the head covering is a hat or a helmet, and the image recording apparatus is incorporated within or disposed onto the hat or helmet. In embodiments where the extending members have a rigid or semi-rigid structure, that structure itself can maintain the image sensors in a substantially fixed position relative to each other. In other embodiments, however, the image sensors may include, for example, on their back side, a device that assists in affixing the image sensor to a hat or helmet. Any suitable such devices can be used, including, but not limited to, Velcro, an adhesive, magnets, or various physical connectors, such as a tongue device that allows the image sensor to fit into certain holes or indentations disposed on or in the hat or helmet.

In some embodiments, the apparatuses disclosed herein include a controller that is in electrical communication with at least one of the two or more image sensors and activates at least one of the image sensors to capture image data. In general, the apparatus has a single controller that activates all of the image sensors. But, in some embodiments, the apparatus may contain two or more controllers that allow one to activate certain image sensors and not others. For example, if the apparatus included some combination of daylight and nighttime image sensors, having multiple controllers may allow one to activate some image sensors and not others depending on the light conditions. The controller(s) can be disposed at any suitable location or combination of locations (if there are two or more) on the apparatus. In some embodiments, a controller is disposed adjacent to the power supply, for example, as part of a common housing with the power supply. In some other embodiments, a controller is disposed adjacent to an image sensor or is disposed on an extension member that extends between the housing containing the power supply and one or more image sensors.

In some embodiments, the apparatuses disclosed herein include a processor that is in electrical communication with the two or more image sensors and is configured to process image data captured by the two or more sensors and to generate processed image data. Processors for processing sensor-captured data are well known in the art. Such processors can programmed (via software) to perform a variety of features, including carrying out Bayer transformations, demosaicing, signal-to-noise reduction, image sharpening, and the like. The processor can also be programmed (via software) to process image/video data from multiple sensors and combine that data to produce processed data representing a substantially uniform panoramic (e.g., 360-degree) view.

The processor can be placed in any suitable location within the apparatus. In some embodiments, the processor is disposed adjacent to the power supply, for example, as part of a common housing with the power supply. Depending on its size, the processor can also be placed in other locations, such as adjacent to an image sensor or disposed on or within an extension member that extends between the housing containing the power supply and one or more image sensors.

In some embodiments disclosed herein, the apparatuses can also include a data storage unit, which, in most embodiments, is any kind of memory unit suitable for the storage of data. In embodiments with no processor (e.g., to save space or weight), the data storage unit may simply store raw data from one or more image sensors. In embodiments with a processor, the data storage unit may store processed data from the image processor. The data storage unit can be placed in any suitable location within the apparatus. In some embodiments, the processor is disposed adjacent to the power supply, for example, as part of a common housing with the power supply. Depending on its size, the data storage unit can also be placed in other locations, such as adjacent to an image sensor or disposed on or within an extension member that extends between the housing containing the power supply and one or more image sensors.

In some embodiments disclosed herein, the apparatuses may also include a transmitter, which transmits processed image data wirelessly to a remote receiver. Such a transmitter can be located in any suitable location, so long as its placement permits ready transmission of data to a location remote from the user of the apparatus. For example, in some embodiments, the transmitter is disposed adjacent to the housing that contains the power supply. In some other embodiments, it is disposed on or within an extension member that extends between the housing containing the power supply and one or more image sensors.

The apparatuses disclosed herein also include a power supply. In general, the power supply is a rechargeable or replaceable battery. Any suitable battery or batteries can be used, including, but not limited to, rechargeable lithium-ion batteries. Any suitable size of battery can be used, depending on the desired weight and usable lifetime of the apparatus. As noted above with reference to FIGS. 1-3, the presently disclosed apparatus permits one to use a larger battery or battery pack than may otherwise be convenient or desirable, as the design of the apparatus permits the power supply to be located at a position that is physically comfortable for the user and which does not have a profile that extends substantially above the head covering device in a vertical direction.

In general, the battery or batteries are disposed within a housing. As noted above, a number of other elements of the apparatus can optionally be disposed within or immediately adjacent to the housing that contains the power supply. As noted above, the power supply is disposed at a location remote from at least one of the two or more image sensors. In some embodiments, the power supply is disposed on or within the posterior of the head covering device. In some other embodiments, the power supply is configured to be disposed remotely from the head covering device, such as on some other portion of the body of the user.

### System for Panoramic Image Recording

In a second aspect, the disclosure provides a system for panoramic image recording, comprising: a head covering device having an external surface, the external surface having an anterior portion and a posterior portion; two or more image sensors, wherein a first image sensor of the two or more image sensors is disposed on the anterior portion of the external surface of the head covering device, and a second image sensor of the two or more image sensors is disposed on the posterior portion of the external surface of the head covering device; a controller that is in electrical communication with the two or more image sensors, and is configured to activate the two or more image sensors to capture image data; a data storage unit that is in electrical communication with the two or more image sensors and the processor, when present, and is configured to store image data captured by the two or more image sensors or processed image data generated by the processor; and a power supply, wherein the power supply is disposed at a location remote from the first image sensor.

The systems disclosed herein have two or more image sensors (or cameras). Any suitable image sensor or camera can be used, as discussed above with reference to the first aspect. The systems disclosed herein have at least two image sensors. In some embodiments, the systems have two image sensors, or three image sensors, or four image sensors, or five image sensors, of six image sensors, of seven image sensors, or eight image sensors, or nine image sensors, or ten image sensors, or eleven image sensors, or twelve image sensors, and so on. The selection of the number of image sensors may depend on a variety of factors, including the scope of view one desires to detect, the aspect of the image sensors, the type of image-related information detected by the image sensors, and the like. In some embodiments, the systems includes four visible-light image sensors.

As noted above, the systems disclosed herein have at least one (or at least two, or at least three) image sensors disposed on the anterior portion of the external surface of a head covering device, and at least one (or at least two, or at least three) image sensors disposed on the posterior portion of the external surface of a head covering device. Moreover, at least one of the two or more image sensors is disposed at a location remote from the power supply. For example, in some embodiments disclosed herein, the power supply (e.g., battery) is contained within a housing that may also include one or more of a controller, a data storage unit (e.g., memory), and a processor. In such embodiments, at least one of the two or more image sensors is disposed at a location remote from the housing. This can be accomplished in any suitable way. For example, in some embodiments, the one or more remote image sensors can be disposed on a member that extends from the housing, either as a flexible piece or a semi-rigid or rigid piece.

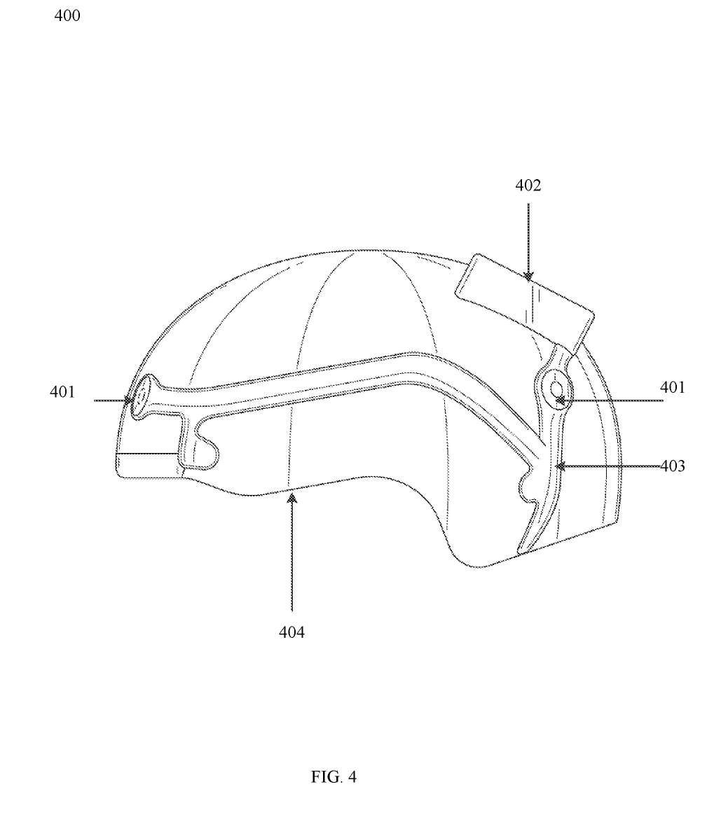

In general, the systems disclosed herein permit panoramic image capturing. In some such embodiments, the systems permit a 360-degree image capturing. An example of such a configuration is disclosed in FIGS. 4-6, described below.

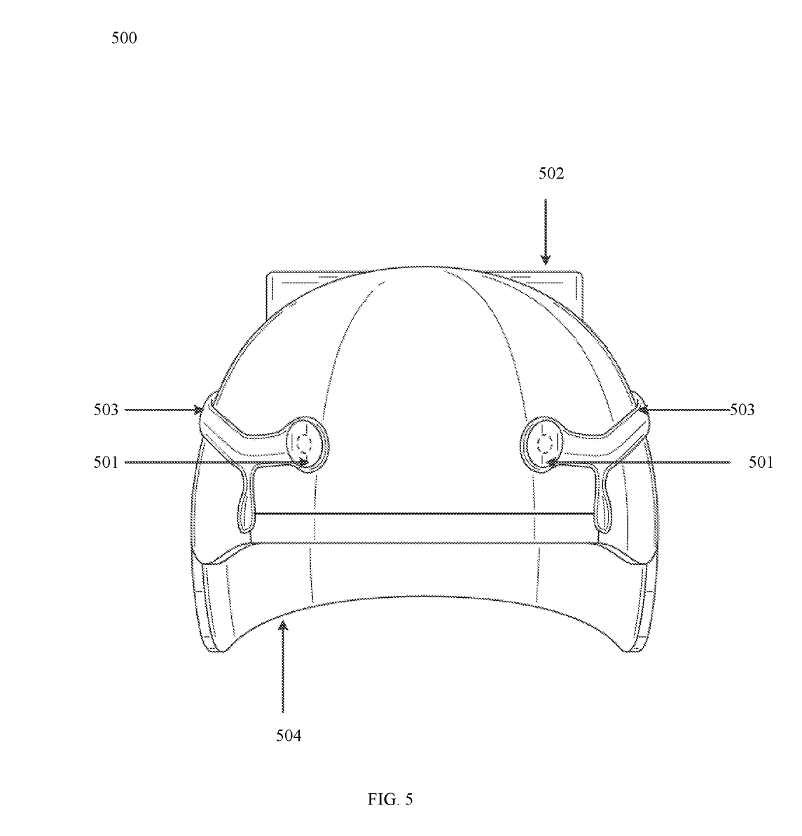

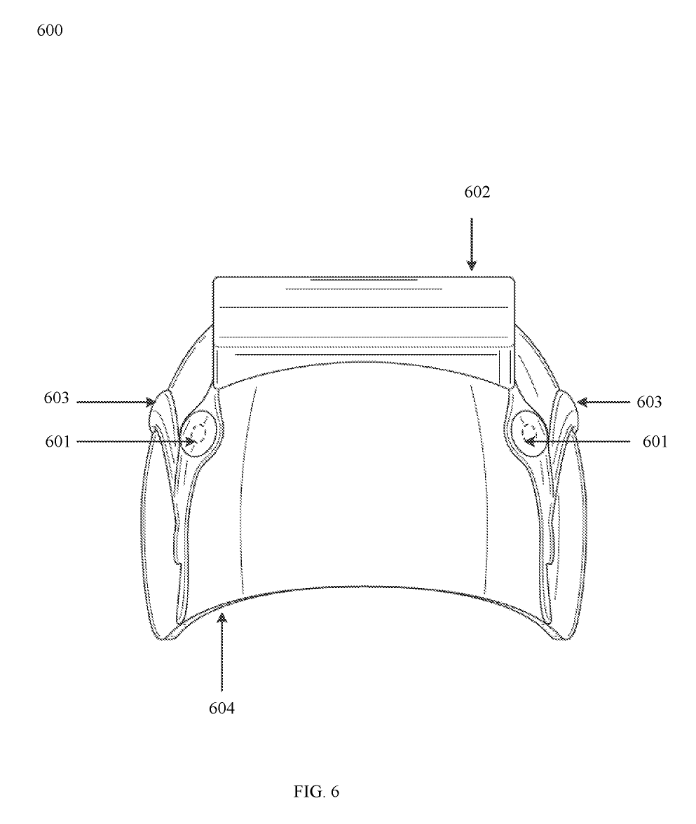

In some embodiments, all of the image sensors are disposed at locations remote from the power supply. In such embodiments, the two or more image sensors are disposed onto member(s) that extend from the housing containing the power supply. FIG. 4 shows a non-limiting example of such a configuration. FIG. 4 shows an image recording system 400 having two remote image sensors 401 and a housing 402 that at least contains a power supply and a member 403 that extends from the housing 402 to permit disposing of the image sensors 401 at locations remote from the housing 402 and disparate from each other, disposed on a helmet 404. The features illustrated in FIG. 4 can easily be extended to embodiments that incorporate additional image sensors and additional members extending from the housing. Also, in some alternative embodiments (not shown), one of the image sensors, such as the rear image sensor shown in FIG. 4, could be incorporated into the housing itself instead of being disposed on the extension member. Also, FIG. 4 shows a left-side view. In some embodiments, the image recording system allows for similar features to be present on the right side of a head covering device. In some embodiments, the image recording system allows for similar features to be present on both the left side and the right side of a head covering device, such that the apparatus has four image sensors and a housing that at least contains a power supply. FIG. 5 shows a front view of such an image recording apparatus 500, where two of the four remote image sensors 501 are connected to an extending member 503 to a housing 502 that at least contains a power supply, disposed on a helmet 504. FIG. 6 shows a front view of such an image recording apparatus 600, where two of the four remote image sensors 601 are connected to an extending member 603 to a housing 602 that at least contains a power supply, disposed on a helmet 604.

The embodiments shown in FIGS. 4-6 illustrate at least certain benefits of the systems disclosed herein. By separating some or all of the image sensors from the power supply, the image sensors can be disposed at locations that fit closely to the head or head covering device (i.e., without substantially increasing the profile) and that are suitable for image capturing, while the power supply can be placed at any location that is convenient without consideration of whether that location is suitable for image collection or not. For example, as illustrated in FIGS. 4-6, the housing containing a power supply is configured to be disposed on the lower anterior portion of a head covering device. This allows for the use of a larger battery, which permits longer lifetime before recharging or replacement. It also allows for placement of the housing containing the power supply at a location that is more comfortable to the user and that does not substantially extend beyond the profile of the head covering device in a vertical direction. By physically separating the image sensors from the housing, one can obtain certain benefits of a larger device without the need to affix a bulky unit atop the user's head.

As noted above, the image sensors are disposed on an external surface of a head covering device. This can be accomplished by any suitable means, as described in detail with reference to the first aspect.

In some embodiments, the systems disclosed herein also include one or more of a controller, a processor, a data storage unit, and a transmitter, according to any embodiments and disposed at any locations, as set forth above with reference to the first aspect. The systems disclosed herein also include a power supply, according to any embodiments and disposed at any locations, as set forth above with reference to the first aspect.

### Uses of Apparatuses and Systems

In certain additional aspects, the foregoing apparatuses and systems can be used in a variety of ways. For example, in at least one aspect, the disclosure provides methods of using apparatuses of the first aspect (according to any of the embodiments disclosed above), comprising: providing an apparatus of the first aspect; and disposing the apparatus on a head covering device, such as a hat, helmet, or other head covering device. In further aspects, the apparatuses and systems disclosed above may be employed in a variety of situations where panoramic still-frame or video recording may be desirable, such as in various recreational activities, athletic activities, and the like.

1. An apparatus for concurrent multiple image recording, comprising:
two or more image sensors, wherein the two or more image sensors are configured to be disposed at disparate locations on an external surface of a head covering device;
a controller that is in electrical communication with the two or more image sensors, and is configured to activate the two or more image sensors to capture image data;
a data storage unit that is in electrical communication with the two or more image sensors or the processor, when present, and is configured to store image data captured by the two or more image sensors or processed image data generated by the processor; and
a power supply, wherein the power supply is configured to be disposed at a location remote from at least one of the two or more image sensors.

2. The apparatus of claim 2, wherein the two or more image sensors are sensors for detecting electromagnetic radiation in the visible light range.

3. The apparatus of claim 1, wherein the two or more image sensors are sensors for detecting electromagnetic radiation in the infrared range.

4. The apparatus of claim 1, wherein at least one of the two or more image sensors is configured to be disposed on an anterior portion of the external surface of the head covering device, and another of the two or more image sensors is configured to be disposed on a posterior portion of the external surface of the head covering device.

5. The apparatus of claim 4, wherein the apparatus comprises at least four image sensors, and wherein at least two of the at least four image sensors is configured to be disposed on an anterior portion of the external surface of the head covering device, and at least two other of the at least four image sensors is configured to be disposed on a posterior portion of the external surface of the head covering device.

6. The apparatus of claim 1, wherein the head covering device is a helmet or a hat.

7. The apparatus of claim 1, wherein the power supply is disposed within a housing, and wherein at least one of the two or more image sensors is disposed on an extension member that extends remotely from the housing.

8. The apparatus of claim 1, wherein the power supply is disposed within a housing, and wherein all of the image sensors of the apparatus are configured to be disposed remotely from the housing and are disposed on one or more extension members that extend remotely from the housing.

9. The apparatus of claim 1, wherein the power supply is configured to be disposed on or within the posterior portion of the head covering device.

10. The apparatus of claim 1, wherein the power supply is configured to be disposed at a location remote from the head covering device.

11. The apparatus of claim 1, wherein the apparatus comprises the processor, and wherein the data storage unit is in electrical communication with the processor.

12. The apparatus of claim 1, where the power supply comprises one or more lithium-ion batteries.

13. A system for panoramic image recording, comprising:
a head covering device having an external surface, the external surface having an anterior portion and a posterior portion;
two or more image sensors, wherein a first image sensor of the two or more image sensors is disposed on the anterior portion of the external surface of the head covering device, and a second image sensor of the two or more image sensors is disposed on the posterior portion of the external surface of the head covering device;
a controller that is in electrical communication with the two or more image sensors, and is configured to activate the two or more image sensors to capture image data;
optionally, a processor that is in electrical communication with the two or more image sensors, and is configured to process image data captured by the two or more image sensors and to generate processed image data; and
a data storage unit that is in electrical communication with the two or more image sensors and the processor, when present, and is configured to store image data captured by the two or more image sensors or processed image data generated by the processor,
a power supply, wherein the power supply is disposed at a location remote from the first image sensor.

14. The system of claim 13, wherein the two or more image sensors are sensors for detecting electromagnetic radiation in the visible light range.

15. The system of claim 13, wherein the two or more image sensors are sensors for detecting electromagnetic radiation in the infrared range.

16. The system of claim 13, wherein the system comprises at least four image sensors, and wherein at least two of the at least four image sensors is disposed on an anterior portion of the external surface of the head covering device, and at least two other of the at least four image sensors is disposed on a posterior portion of the external surface of the head covering device.

17. (canceled)

18. The system of claim 13, wherein the power supply is disposed within a housing, and wherein at least one of the two or more image sensors is disposed on an extension member that extends remotely from the housing.

19. The system of claim 13, wherein the power supply is disposed within a housing, and wherein all of the image sensors of the apparatus are disposed remotely from the housing and are disposed on one or more extension members that extend remotely from the housing.

20. The system of claim 13, wherein the power supply is disposed on or within the posterior portion of the head covering device.

21. The system of claim 13, wherein the power supply is at a location remote from the head covering device.

22. (canceled)

23. (canceled)
